(19) United States
(12) Patent Application Publication
(10) Pub. No.: US 2012/0230604 A1
(43) Pub. Date: Sep. 13, 2012

(54) IMAGE PROCESSING APPARATUS, IMAGE PROCESSING METHOD AND PROGRAM

(75) Inventors: Hiroaki Yamajo, Tokyo (JP); Koji Aoyama, Saitama (JP); Tetsuji Inada, Kanagawa (JP); Tomonori Tsutsumi, Tokyo (JP); Yosuke Yamamoto, Chiba (JP); Kazuki Yokoyama, Kanagawa (JP)

(73) Assignee: SONY CORPORATION, Tokyo (JP)

(21) Appl. No.: 13/406,842

(22) Filed: Feb. 28, 2012

(30) Foreign Application Priority Data
Mar. 8, 2011 (JP) 2011-050479

(51) Int. Cl. G06K 9/32; G06K 9/40

(52) U.S. Cl. 382/275

(57) ABSTRACT

Disclosed herein is an image processing apparatus, including a noise detection section, a scaling section, an adjustment signal production section, and a correction section. The noise detection section is adapted to detect block noise based on an input image signal in a compression coded form and output noise information indicative of the detected block noise. The scaling section is adapted to carry out a scaling process for carrying out enlargement or reduction of an image indicated by the input image signal for the input image signal and output scaling information indicative of an enlargement ratio or a reduction ratio. The adjustment signal production section is adapted to output an adjustment signal indicative a degree of correction based on the noise information and the scaling information. The correction section is adapted to correct the image signal for which the scaling process is carried out based on the adjustment signal.

### BACKGROUND

The present disclosure relates to an image processing apparatus, an image processing method and a program.

For example, in the case where an image is compressed using a coding method which uses discrete cosine transform (DCT) or the like, block distortion, hereinafter referred to as “block noise,” sometimes appears. Thus, a technique has been developed wherein, by reducing block noise to correct an image signal, improvement in picture quality is achieved. As a technique which achieves improvement in picture quality by reducing block noise to correct an image signal, for example, a technique disclosed in Japanese Patent Laid-Open No. Hei 10-229546 is available.

### SUMMARY

In such a related-art technique for improving picture quality as that disclosed in Japanese Patent Laid-Open No. Hei 10-229546, block noise of an image signal indicative of an image in a compression coded form is reduced using, for example, discrete cosine transform or the like, and an image process such as a contour emphasis process is carried out for the image signal whose block noise is reduced. Therefore, since the noise reduction process for reducing block noise and the image process for improving the picture quality are carried out, improvement in picture quality can be achieved by using the technique in the past. It is to be noted that an image signal indicative of an image in a compression coded form is sometimes referred to as “image signal in a compression coded form.”

Here, for example, if a scaling process for expanding or reducing an image indicated by an image signal is carried out before the image process is carried out after the noise reduction process is carried out, then the possibility that the position at which block noise exists may vary is high. Since the technique in the past does not take it into consideration that the position of block noise may be varied by the scaling process, when the image process such as a contour emphasis process is carried out, emphasis of reduced block noise possibly occurs. Accordingly, even if the technique in the past is used, improvement in picture quality cannot necessarily be achieved.

Therefore, it is desirable to provide an image processing apparatus, an image processing method and a program which can achieve improvement in picture quality in the case where a scaling process is carried out for an image signal in a compression coded form.

According to the technology disclosed herein, there is provided an image processing apparatus, including:

a noise detection section adapted to detect block noise based on an input image signal in a compression coded form and output noise information indicative of the detected block noise;

a scaling section adapted to carry out a scaling process for carrying out enlargement or reduction of an image indicated by the input image signal for the input image signal and output scaling information indicative of an enlargement ratio or a reduction ratio;

an adjustment signal production section adapted to output an adjustment signal indicative a degree of correction based on the noise information and the scaling information; and

a correction section adapted to correct the image signal for which the scaling process is carried out based on the adjustment signal.

Further, according to the disclosed technology, there is provided an image processing method, including:

detecting block noise based on an input image signal in a compression coded form and outputting noise information indicative of detected block noise;

carrying out a scaling process for carrying out enlargement or reduction of an image indicated by the input image signal for the input image signal and outputting scaling information indicative of an enlargement ratio or a reduction ratio;

outputting an adjustment signal indicative of a degree of correction based on the noise information and the scaling information; and

correcting the image signal for which the scaling process is carried out based on the adjustment signal.

According to the disclosed technology, also there is provided a program for causing a computer to execute:

detecting block noise based on an input image signal in a compression coded form and outputting noise information indicative of detected block noise;

carrying out a scaling process for carrying out enlargement or reduction of an image indicated by the input image signal for the input image signal and outputting scaling information indicative of an enlargement ratio or a reduction ratio;

outputting an adjustment signal indicative of a degree of correction based on the noise information and the scaling information; and

correcting the image signal for which the scaling process is carried out based on the adjustment signal.

In summary, according to the disclosed technology, improvement in picture quality can be anticipated in the case where a scaling process is carried out for an image signal in a compression coded form.

### BRIEF DESCRIPTION OF THE DRAWINGS

FIG. 1 is a block diagram showing an example of a configuration of an image processing apparatus according to the technology disclosed herein;

FIGS. 2, 3 and 4 are diagrammatic views illustrating an example of a detection method of a block noise intensity by the image processing apparatus;

FIG. 5 is a block diagram showing a first configuration example of an adjustment signal production section of the image processing apparatus;

FIG. 6 is a diagrammatic view illustrating an example of a production method of an adjustment signal by the image processing apparatus;

FIG. 7 is a block diagram showing a second configuration example of the adjustment signal production section of the image processing apparatus; and

FIGS. 8A, 8B, 8C and 9 are diagrammatic views illustrating an example of a local correction process by the image processing apparatus.

### DETAILED DESCRIPTION OF THE PREFERRED EMBODIMENT

In the following, a preferred embodiment of the technology disclosed herein is described in detail with reference to the accompanying drawings. It is to be noted that, in the present specification and the accompanying drawings, components having substantially like functions are denoted by like reference characters and overlapping description of them is omitted herein.

The description is given in the following order:

1. Image processing method according to the embodiment

2. Image processing apparatus according to the embodiment

3. Program according to the embodiment

### 1. Image Processing Method According to the Embodiment

Before a configuration of an image processing apparatus 100 according to an embodiment of the disclosed technology is described, an outline of an image processing method according to the disclosed technology is described. In the following description, it is assumed that the image processing apparatus 100 carries out processing of the image processing method according to the embodiment.

As described hereinabove, if a scaling process for carrying out enlargement or reduction in scale of an image such as a still image or a moving image indicated by an image signal before an image process is carried out after a noise reduction process is carried out, then the possibility that the position at which block noise has existed may vary is high. Therefore, the image processing apparatus 100 according to the disclosed technology produces, based on noise information indicative of block noise detected based on an image signal, which is hereinafter referred to sometimes as “input image signal,” in a compression coded form of a processing object and scaling information indicative of an enlargement ratio or a reduction ratio in the scaling process, an adjustment signal indicative of a degree of correction. Then, the image processing apparatus 100 corrects, based on the adjustment signal, the image signal, hereinafter referred to sometimes as “scaling image signal,” obtained by carrying out the scaling process for the input image signal.

The input image signal in the disclosed technology may be an image signal obtained, for example, by the image processing apparatus 100 receiving, directly or indirectly through a set top box or the like, and decoding a broadcasting wave transmitted from a television tower. However, the input image signal in the disclosed technology is not limited to that described above. For example, it is possible for the image processing apparatus 100 to process an image signal transmitted through a network or directly from an external apparatus as the input image signal. Or the image processing apparatus 100 may process an image signal obtained by decoding an image signal stored in a storage section (described later) and an external storage medium which can be removably loaded in the image processing apparatus 100 as the input image signal. Further, as the input image signal, an image signal coded in accordance with a coding method which carries out compression coding in a unit of a block configured from a plurality of pixels like MPEG-4 (ISO/IEC 14496) (MPEG standing for Motion Picture Experts Group, ISO standing for International Standards Organization, IEC standing for International Electrotechnical Commission), MPEG-2 (ISO/IEC 13818), MPEG-1, H.261, H.263 or H.264. In the following, description is given taking a case in which the input signal in the disclosed technology is an image signal coded in a unit of a block of 8×8 pixels, that is, taking a case in which the number of pixels of a block unit is “8,” as an example.

Further, the noise information relating to the disclosed technology may include, for example, information representative of the position of a block boundary and information representative of a block noise intensity, that is, information indicative of an intensity of block noise. More particularly, the image processing apparatus 100 uses data, hereinafter referred to sometimes as “block position data b_pos,” indicative of the start position of a block in an image and data, hereinafter referred to sometimes as “block size data b_size,” indicative of a size of the block, as information indicative of the position of the block boundary. Here, the block position data b_pos may be coordinate data indicative of a coordinate of a pixel in the case where, for example, a predetermined position of an image such as a left lower corner of an image is determined as the origin. Meanwhile, the block size data b_size may be data indicative of a number of pixels which configure a block unit. It is to be noted that the image processing apparatus 100 can decide the size of a block using, for example, a detection method of a position of a block boundary hereinafter described. The image processing apparatus 100 can specify the block position data b_pos and the block size data b_size corresponding to each block based on a coding method of an input image signal. Further, the image processing apparatus 100 uses, for example, data, hereinafter referred to sometimes as “data b_str,” indicative of an intensity of block noise as information indicative of the block noise intensity. A detection method of a block noise intensity in the disclosed technology is hereinafter described.

Further, the adjustment information in the disclosed technology may be, for example, a signal for adjusting the gain of an image signal, that is, a mask gain signal. It is to be noted that the adjustment signal in the disclosed technology is not limited to a signal for adjusting the gain of an image signal. For example, as the adjustment signal in the disclosed technology, a signal which defines a degree of an arbitrary image process relating to correction of an image signal by a correction section hereinafter described provided in the image processing apparatus 100, for example, a signal which defines a level of a process corresponding to an image signal by the correction section. The following description is given principally taking a case in which the image processing apparatus 100 in the disclosed technology disclosed technology produces an adjustment signal for adjusting the gain of an image signal as an example.

The image processing apparatus 100 in the disclosed technology produces an adjustment signal based on noise information and scaling information and corrects a scaling image signal based on the adjustment signal as described hereinabove. Therefore, even if the image processing apparatus 100 carries out, for example, linear scaling or nonlinear scaling (for example, panorama wide scaling or overscan) for an input image signal, block noise is not emphasized by the image process, that is, by the correction process, at all. In other words, the image processing apparatus 100 can implement a more natural image process even for an image which suffers from block noise.

Accordingly, in the case where a scaling process is carried out for an image signal in a compression coded form, the image processing apparatus 100 can achieve high picture quality.

In the following, an example of a configuration according to the disclosed technology is described and also a particular example of processing by the image processing method according to the disclosed technology is described.

### 2. Image Processing Apparatus According to the Embodiment

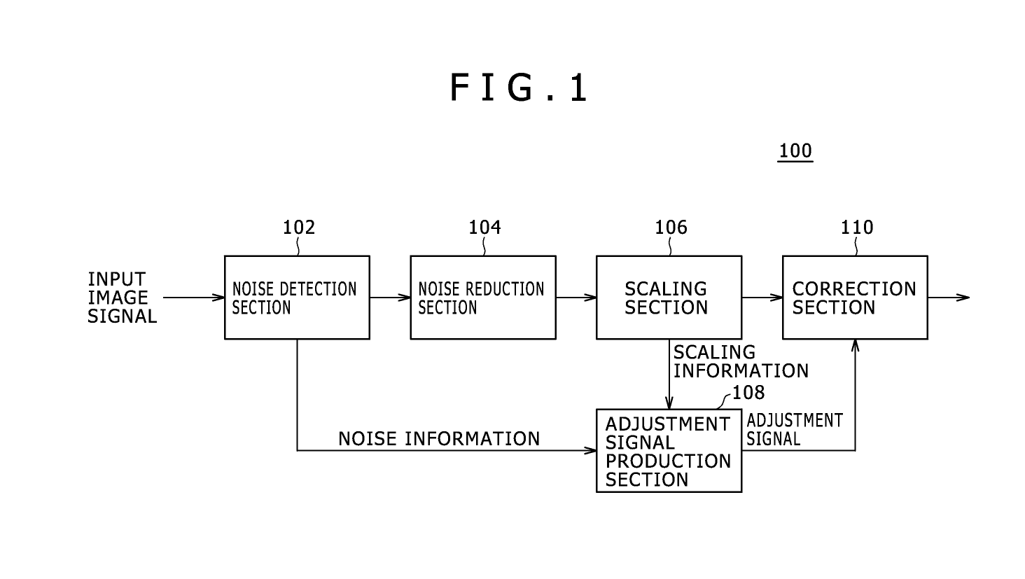

FIG. 1 shows in block diagram an example of a configuration of the image processing apparatus 100 according to the disclosed technology.

The image processing apparatus 100 includes, for example, a noise detection section 102, a noise reduction section 104, a scaling section 106, an adjustment signal production section 108 and a correction section 110.

The image processing apparatus 100 may further include, for example, a control section not shown, a ROM (Read Only Memory) not shown, a RAM (Random Access Memory) not shown, a storage section not shown, a decoder, an operation section not shown which can be operated by a user, a display section not shown for displaying various screen images on a display screen thereof, and a communication section not shown for communicating with an external apparatus. The components mentioned of the image processing apparatus 100 are connected to each other, for example, by a bus as a transmission line for data.

The control section may be configured, for example, from an MPU (Micro Processing Unit), various processing circuits and so forth and controls the entire image processing apparatus 100. Further, the control section may play roles, for example, of the decoder or the noise detection section 102, noise reduction section 104, scaling section 106, adjustment signal production section 108 and correction section 110 hereinafter described. Further, the control section may play a role of carrying out a process for an image signal for which various image processes have been carried out such as, for example, encoding an image signal for which an image process has been carried out by the correction section 110 to store in the storage section.

The ROM stores programs and controlling parameters such as arithmetic operation parameters which are used by the control section. The RAM temporarily stores a program to be executed by the control section or the like.

The storage section is storage means provided in the image processing apparatus 100 and stores various data such as, for example, image data and applications. The storage section may be, for example, a magnetic recording medium such as a hard disk, a nonvolatile memory such as an EEPROM (Electrically Erasable and Programmable Read Only Memory) or a flash memory.

The operation section may be, for example, buttons, direction keys, a rotational type selector such as a jog dial or a combination of them. Further, it is possible to connect the image processing apparatus 100 to an operation inputting device such as, for example, a keyboard or a mouse as an external apparatus of the image processing apparatus 100.

The display section may be, for example, a liquid crystal display unit, or an organic EL (Electroluminescence) display unit also called OLED (Organic Light Emitting Diode) display unit. It is to be noted that the display section may otherwise be a device which can carry out display and allows user operation thereof like, for example, a touch screen.

The communication section is communication means provided in the image processing apparatus 100 and communicates with an external apparatus through a network or directly by wire or wireless communication. The communication section may be, for example, a communication antenna and a RF (Radio Frequency) circuit (wireless communication), an IEEE802.15.1 port and a transmission and reception circuit (wireless communication), an IEEE802.11b port and a transmission and reception circuit (wireless communication), a LAN (Local Area Network) terminal and a transmission and reception circuit (wire communication) or the like. Further, the network may be a wire network such as, for example, a LAN or a WAN (Wide Area Network), a wireless network such as a wireless WAN (WWAN: Wireless Wide Area Network) through a base state, the Internet in which a communication protocol such as TCP/IP (Transmission Control Protocol/Internet Protocol) is used, or the like.

In the following, the configuration example of the image processing apparatus 100 according to the disclosed technology shown in FIG. 1 and an example of processing by the image processing apparatus 100 relating to the image processing method are described.

The noise detection section 102 detects block noise based on an input image signal and outputs noise information representative of the detected block noise. Here, the noise information includes, for example, information b_pos and b_size indicative of the position of a block boundary and information b_str indicative of a block noise intensity. Although the noise detection section 102 outputs noise information corresponding to all blocks irrespective of whether or not block noise is detected, processing by the noise detection section 102 is not limited to that described above. For example, the noise detection section 102 may selectively output noise information corresponding to those blocks with regard to which it is decided that block noise is detected. The noise detection section 102 decides that clock noise is not detected, for example, when the value work(x) indicative of an offset characteristic of a block calculated by a detection method of a block noise intensity hereinafter described is equal to or lower than 0.

### Example of the Detection Method of the Position of a Block Boundary

Here, an example of a detection method of the position of a block boundary by the image processing apparatus 100 in the disclosed technology is described. In the following description, a case in which the image processing apparatus 100 decides the position of a block boundary in a horizontal direction of an image indicated by an input image signal is taken as an example. It is to be noted that also the position of a block boundary in a vertical direction of an image indicated by an input image signal can be detected by the image processing apparatus 100 using a similar method.

The image processing apparatus 100 integrates, for example, a difference signal between adjacent pixels of an input image signal in the horizontal direction to detect the position of a block boundary.

More particularly, the image processing apparatus 100 calculates, for example, a difference absolute value between pixel values D such as, for example, luminance values, of pixels adjacent each other in the horizontal direction, that is, |D(x)−D(x+1)|. Further, the image processing apparatus 100 totalizes the calculated difference absolute values in the vertical direction to calculate a totalized value for each of the positions in the horizontal direction. Here, the image processing apparatus 100 may calculate a histogram where the totalized value is a frequency and the position in the horizontal direction is a class. Further, the image processing apparatus 100 uses the calculated totalized values at the individual positions in the horizontal direction and a predetermined threshold value for decision of a block position to decide any position in the horizontal direction at which the totalized value is equal to or higher than the threshold value (or is higher than the threshold value). The threshold value here may be a fixed value set in advance or may be an adjustable variable value. Then, the image processing apparatus 100 decides the decided position, which corresponds, for example, to a peak position in the histogram, as a start position of a block, or in other words, as a position of a block boundary. Further, the image processing apparatus 100 decides the distance between such decided positions as a size of the block.

The image processing apparatus 100 uses, for example, such a method as described above to detect the position of a block boundary. It is to be noted that naturally the detection method of the position of a block boundary by the image processing apparatus 100 according to the disclosed technology is not limited to that described above.

### Example of the Detection Method of a Block Noise Intensity

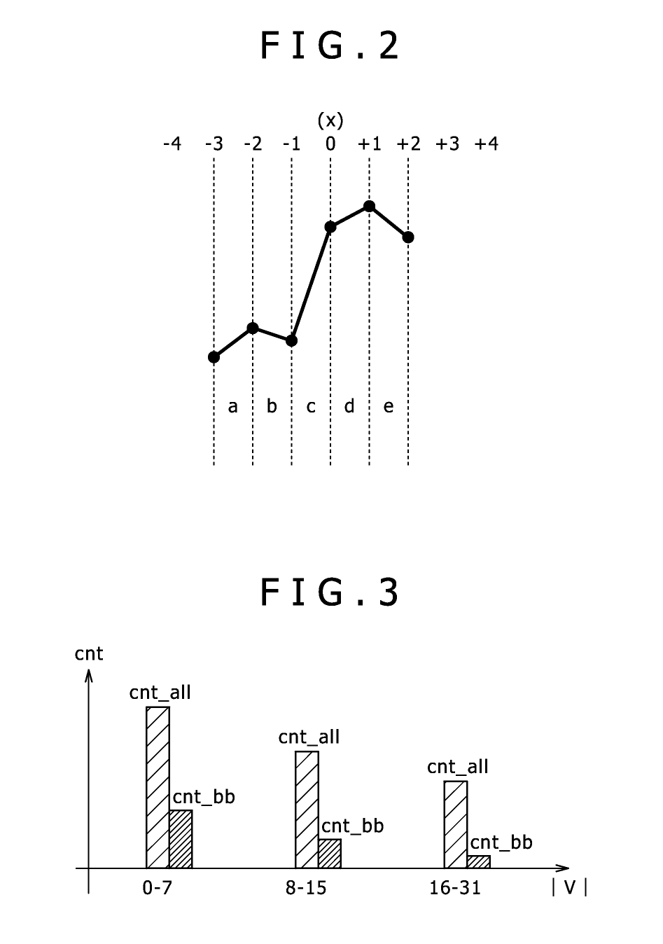

Now, an example of a detection method of a block noise intensity by the image processing apparatus 100 according to the disclosed technology is described. FIGS. 2, 3 and 4 illustrate an example of the detection method of a block noise intensity by the image processing apparatus 100. In the following, an example of the detection method of a block noise intensity is described taking a case in which the image processing apparatus 100 detects an intensity of block noise of an image indicated by an input image signal in the horizontal direction as an example. It is to be noted that the image processing apparatus 100 can detect also the intensity of block noise in the vertical direction of an image indicated by an input image signal using a similar method.

The image processing apparatus 100 calculates a difference absolute value based on, for example, a pixel value D such as, for example, a luminance value of a noticed pixel x and a pixel value D of another pixel in the proximity of the noticed pixel x. In the example illustrated in FIG. 2, the image processing apparatus 100 calculates difference absolute values a to e, for example, in accordance with the following expressions 1 to 5, respectively:

a =|D(x−2)−D(x−3)| expression 1

b=|D(x−1)−D(x−2)| expression 2

c=|D(x)−D(x−1)| expression 3

d=|D(x+1)−D(x)| expression 4

e=|D(x+2)−D(x+1)| expression 5

It is to be noted that, for example, if no pixel exists in the proximity of the noticed pixel x or if a sufficient number of pixels for detection are not available, then the image processing apparatus 100 may not carry out a process for detection of the block noise intensity regarding the noticed pixel x.

After the difference absolute values a to e are calculated, the image processing apparatus 100 calculates a value work(x) indicative of an offset characteristic of the block corresponding to the noticed pixel x, for example, in accordance with the following expression 6:

work(x)=c−(a+b+d+e)/4 expression 6

The expression 6 above represents arithmetic operation for comparing the offset c corresponding to the position of the noticed pixel x and an average value of peripheral offsets.

For example, if the value of the offset work(x) is equal to or lower than 0, then the image processing apparatus 100 decides that no block noise is detected, but if the value of the offset work(x) is higher than 0, the image processing apparatus 100 decides that block noise is detected.

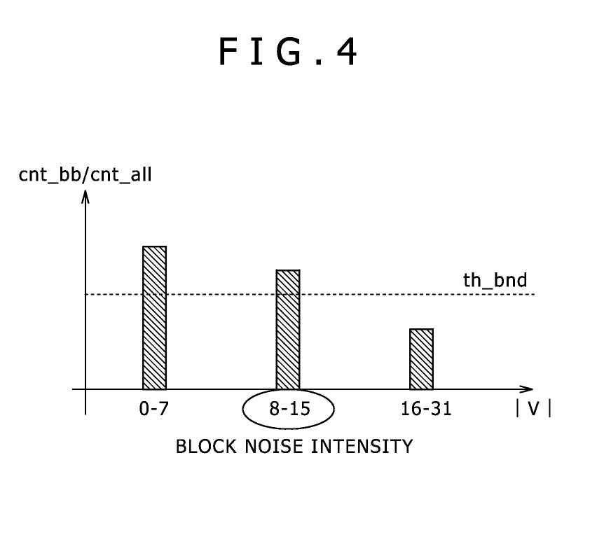

The image processing apparatus 100 calculates, for each level, a value cnt_all(|V|) obtained by totalizing the value work(x) over an overall image for each level and a value cnt_bb(|V|) obtained by totalizing the offset work(x) at the coordinate of a block boundary for each level as seen in FIG. 3. Then, the image processing apparatus 100 calculates “cnt_bb(|V|)/cnt_all(|V|)” for each level and detects a maximum level for which the calculated “cnt_bb(|V|)/cnt_all(|V|)” value exceeds a predetermined threshold value th_bnd as a block noise intensity as seen in FIG. 4.

While the image processing apparatus 100 sets, for example, a value indicative of a level corresponding to the detected block noise, for example, a number for the identification of the level, as b_str, the processing by the image processing apparatus 100 is not limited to that described above. For example, the image processing apparatus 100 can set a value associated with a number for the identification of a level as the information b_str. Further, while the predetermined threshold value th_bnd may be, for example, a value determined in advance, the predetermined threshold value th bnd is not limited to that described above. For example, the predetermined threshold value th_bnd may be a value set by a user of the image processing apparatus 100. The user of the image processing apparatus 100 is hereinafter referred to sometimes as user.

The image processing apparatus 100 detects a block noise intensity by carrying out, for example, such processing as described above. It is to be noted that naturally the detection method of a block noise intensity by the image processing apparatus 100 according to the disclosed technology is not limited to that described above.

Referring back to FIG. 1, the configuration example of the image processing apparatus 100 according to the disclosed technology is described. The noise detection section 102 carries out, for example, such processing of the detection method as described above to output noise information. Further, the noise detection section 102 transmits the input image signal to the noise reduction section 104. It is to be noted that the configuration of the image processing apparatus 100 according to the disclosed technology is not limited to a configuration wherein the noise detection section 102 transmits the input image signal to the noise reduction section 104. For example, the image processing apparatus 100 may input the input image signal to the noise reduction section 104 without the intervention of the noise detection section 102.

The noise detection section 102 can be implemented by a processing circuit for the exclusive use having an arbitrary configuration for carrying out processing, for example, of such a detection method as described above. However, the configuration of the noise detection section 102 is not limited to that described above. For example, in the image processing apparatus 100, the control section may play a role of the noise detection section 102, or the noise detection section 102 may be a processing circuit for universal use which can carry out also some other processing.

The noise reduction section 104 is configured, for example, from a filter circuit and reduces block noise included in the input image signal. Further, the noise reduction section 104 transmits the input image signal whose block noise is reduced to the scaling section 106.

While the noise reduction section 104 carries out its processing, for example, irrespective of a result of detection of block noise by the noise detection section 102, the processing by the noise reduction section 104 is not limited to that just described. For example, the noise reduction section 104 may carry out reduction of block noise selectively based on noise information transmitted thereto from the noise detection section 102. In the case just described, the noise reduction section 104 is configured, for example, such that the input image signal is selectively inputted to a circuit for noise reduction such as a filter circuit based on noise information or such that a circuit for noise reduction is selectively enabled based on noise information.

The scaling section 106 carries out, for an input image signal transmitted thereto, a scaling process of enlarging or reducing an image indicated by the input image signal. Then, the scaling section 106 transmits resulting scaling information to the adjustment signal production section 108 and transmits a scaling image signal to the correction section 110.

The scaling process by the scaling section 106 may include, for example, a process of carrying out linear scaling or a process of nonlinear scaling such as, for example, panorama wide scaling or over scanning. While the scaling section 106 can be implemented from a processing circuit for exclusive use having an arbitrary configuration for carrying out such a scaling process as described above. However, the configuration of the scaling section 106 is not limited to that described above. For example, in the image processing apparatus 100 according to the disclosed technology, the control section may play a role of the scaling section 106. Or, the scaling section 106 may be a processing circuit for universal use which can carry out also some other processes.

The adjustment signal production section 108 produces an adjustment signal based on noise information transmitted thereto from the noise detection section 102 and scaling information transmitted thereto from the scaling section 106. Then, the adjustment signal production section 108 transmits the produced adjustment signal to the correction section 110.

The processing by the adjustment signal production section 108 is not limited to the process of producing an adjustment signal based on noise information transmitted thereto from the noise detection section 102. For example, the decoder can specify, upon decoding processing, a position or an intensity of block noise. Therefore, if noise information indicative of a position or an intensity of block noise specified, for example, by the decoder provided in the image processing apparatus 100 or by a decoder externally of the image processing apparatus 100 is transmitted to the adjustment signal production section 108, then the adjustment signal production section 108 may use the noise information transmitted thereto from the decoder in place of noise information transmitted thereto from the noise detection section 102 to carry out its processing. In the following, a more particular process of the adjustment signal production section 108 is described taking a case in which the adjustment signal production section 108 produces an adjustment signal using noise information transmitted thereto from the noise detection section 102 as an example.

### Configuration Examples of the Adjustment Signal Production Section 108

### (1) FIRST CONFIGURATION EXAMPLE

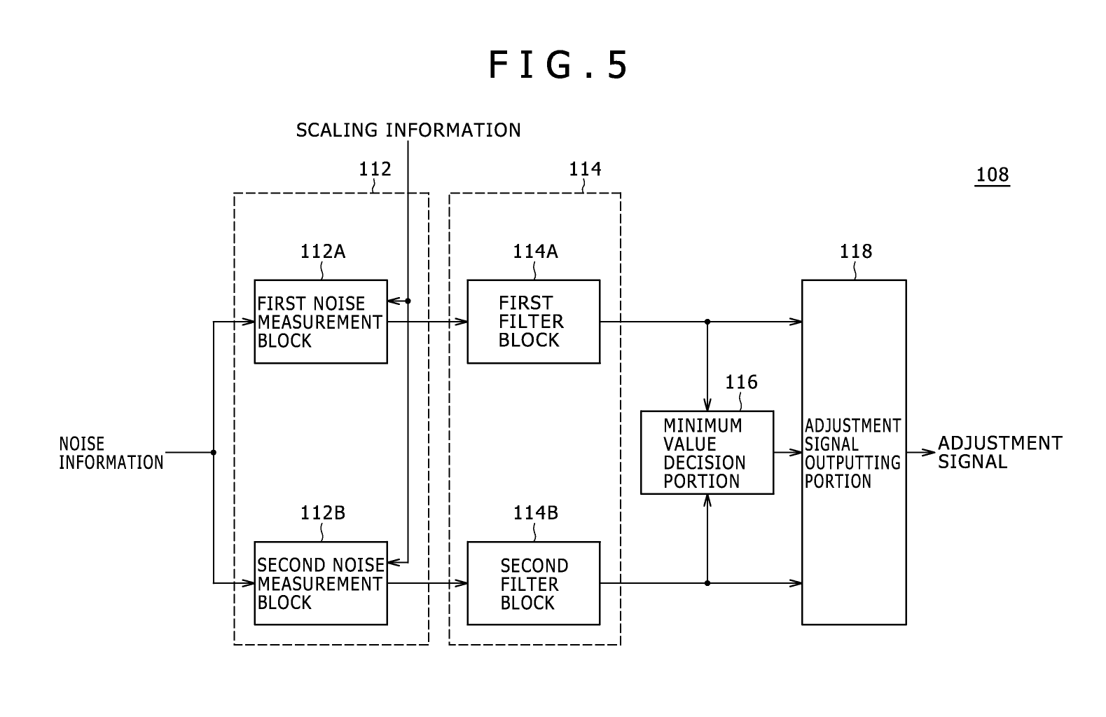

FIG. 5 shows a first example of a configuration of the adjustment signal production section 108 in the image processing apparatus 100 according to the disclosed technology.

The adjustment signal production section 108 according to the first configuration example includes, for example, a noise measurement portion 112, a filter portion 114, a minimum value decision portion 116 and an adjustment signal outputting portion 118.

The noise measurement portion 112 specifies, based on noise information and scaling information, a distance, hereinafter referred to sometimes as “distance b_dist,” from a block boundary of block noise in an image enlarged or reduced by the scaling process. FIG. 5 shows a configuration wherein the noise measurement portion 112 includes a first noise measurement block 112A for specifying the distance from a block boundary in the horizontal direction and a second noise measurement block 112B for specifying the distance from a block boundary in the vertical direction.

It is to be noted that the noise measurement portion 112 according to the disclosed technology is not limited to the configuration wherein both of the distance from a block boundary in the horizontal direction and the distance from a block boundary in the vertical direction are specified. For example, the noise measurement portion 112 may otherwise be configured such that it specifies one of the distance from a block boundary in the horizontal direction and the distance from a block boundary in the vertical direction in response to the processing by the correction section 110.

Example of the Specification Method of the Distance from a Block Boundary

Here, an example of the specification method of the distance from a block boundary by the image processing apparatus 100 according to the disclosed technology is described. In the following, an example of the specification method of the distance from a block boundary is described taking a case in which the image processing apparatus 100 specifies the distance from a block boundary in the horizontal direction as an example. It is to be noted that the image processing apparatus 100 can specify the distance from a block boundary in the vertical direction using a similar method.

The image processing apparatus 100 carries out arithmetic operation, for example, of the expressions 7 and 8 given below using, for example, information b_pos and b_size indicative of the position of a block boundary included in noise information to calculate the distance b_dist. The expressions 7 and 8 indicate an example of a calculation method of the distance b_dist in the case where the pixel number of a block unit is “8.” Further, “mod(d, X)” in the expression 7 represents the remainder of X where d is the divisor, and “rate” is the enlargement rate or the reduction rate indicated by the scaling information. Meanwhile, the expression 8 represents arithmetic operation of converting the distance (0 to 7) corresponding to the pixel number “8” of a block unit into a distance (0 to 3) corresponding to an example of processing by the adjustment signal outputting portion 118 hereinafter described.

b_phase(x)=mod(8, x/{rate×b_size/8}−b_pos) expression 7

b_dist(x)=b_phase(x)>4 ?7−b_phase(x): b_phase(x) expression 8

The image processing apparatus 100 specifies the distance from a block boundary by carrying out, for example, such processing as described above. It is to be noted that naturally the specification method of the distance from a block boundary by the image processing apparatus 100 according to the present disclosure is not limited to that described above.

The noise measurement portion 112 carries out, for example, the processing described above by means of the first noise measurement block 112A and the second noise measurement block 112B. Then, the first noise measurement block 112A outputs a specified distance b_dist_H from a block boundary in the horizontal direction, and the second noise measurement block 112B outputs a specified distance b_dist_V from a block boundary in the vertical direction. While the distances b_dist_H and b_dist_V may be 2-bit digital data, they are not limited to 2-bit digital data.

Further, while the noise measurement portion 112 can be implemented from a processing circuit for exclusive use of an arbitrary configuration for carrying out, for example, such processing of the specification method as described above, the configuration of the noise measurement portion 112 is not limited to that described above. For example, in the image processing apparatus 100 according the disclosed technology, the controlling section may play a role of the noise measurement portion 112, or the noise measurement portion 112 may be a processing circuit for universal use which can carry out some other processing.

The filter portion 114 is configured from a filter circuit such as, for example, a low-pass filter and filters the distance b_dist transmitted thereto from the noise measurement portion 112.

FIG. 5 shows the filter portion 114 which is configured from a first filter block 114A corresponding to the first noise measurement block 112A and a second filter block 114B corresponding to the second noise measurement block 112B. However, the configuration of the filter portion 114 according to the disclosed technology is not limited to that described above. For example, in the case where the noise measurement portion 112 is configured such that it specifies one of the distance from a block boundary in the horizontal direction and the distance from a block boundary in the vertical direction, the filter portion 114 may be configured from one of the first filter block 114A and the second filter block 114B corresponding to the noise measurement portion 112.

For example, the adjustment signal production section 108 can take a configuration which does not include the filter portion 114.

The minimum value decision portion 116 is configured, for example, from a comparison circuit, and decides a minimum value of the horizontal distance b dist H and the vertical distance b_dist_V of a corresponding block and transmits the minimum values to the adjustment signal outputting portion 118. It is to be noted that in the case where the noise measurement portion 112 is configured such that it specifies one of the distance from a block boundary in the horizontal direction and the distance from a block boundary in the vertical direction, the adjustment signal production section 108 may not include the minimum value decision portion 116.

The adjustment signal outputting portion 118 produces an adjustment signal corresponding to the minimum values of the distances b_dist_H and b_dist_V transmitted thereto and outputs the produced adjustment signal.

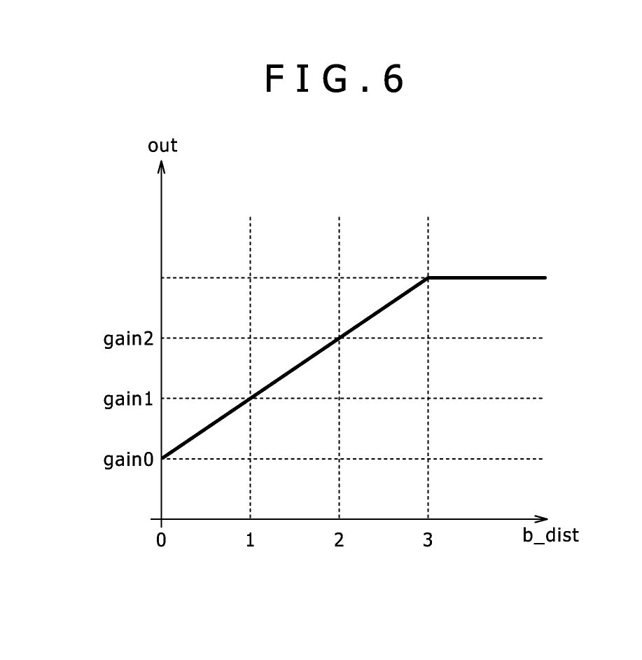

FIG. 6 illustrates an example of a production method of an adjustment signal by the image processing apparatus 100 according to the disclosed technology. In particular, FIG. 6 illustrates an example of a gain curve which is used for production of an adjustment signal by the adjustment signal production section 108 (adjustment signal outputting portion 118) in the case where the image processing apparatus 100 outputs an adjustment signal for adjusting the gain of an image signal.

The image processing apparatus 100 stores a lookup table, in which data indicative of such a gain curve as shown in FIG. 6 or the distance b_dist and adjustment amounts for the gain are associated in a one-by-one corresponding relationship with each other in the storage section, ROM or the like, for example, for each process by the correction section 110 or a type of a scaling process carried out by the scaling section 106. Further, for example, in the case where the correction section 110 carries out a frequency separation type contour emphasis process, the image processing apparatus 100 may store a gain curve or a lookup table for each frequency band. In the case just described, the image processing apparatus 100 can carry out correction of an image based on a frequency characteristic of noise of an input image signal such as, for example, to moderate the contour emphasis process in a low frequency band or a high frequency band.

The adjustment signal outputting portion 118 produces an adjustment signal corresponding to the distances b_dist_H and b_dist_V and the minimum values to be transmitted, for example, for each of the processes by the correction section 110 using the gain curve described hereinabove and for each frequency band. Then, the adjustment signal outputting portion 118 outputs the produced adjustment signals.

It is to be noted that, as described hereinabove, the image processing apparatus 100 according to the disclosed technology can produce not only an adjustment signal for adjusting an image signal but also an adjustment signal representative of, for example, a degree of an image process other than adjustment of the gain. In the case where an adjustment signal representative of a degree of an image process is produced, the image processing apparatus 100 stores a lookup table, in which, for example, values indicative of the distance b_dist and the degree of an image process are associated in a one-by-one corresponding relationship to each other, for each process by the correction section 110, for each frequency band or for each type of the scaling process carried out by the scaling section 106 in the storage section, the ROM or the like. Then, similarly as in the case where an adjustment signal for adjusting the gain of an image signal is produced, the image processing apparatus 100 uses the lookup table to produce adjustment signals corresponding to the distances b_dist_H and b_dist_V and minimum values to be transmitted, for example, for each process by the correction section 110, for each frequency band or the like.

The adjustment signal production section 108 according to the first configuration example can produce an adjustment signal based on noise information and scaling information using, for example, the configuration shown in FIG. 5. It is to be noted that the configuration of the adjustment signal production section 108 in the disclosed technology is not limited to the configuration shown in FIG. 5.

### (2) SECOND CONFIGURATION EXAMPLE

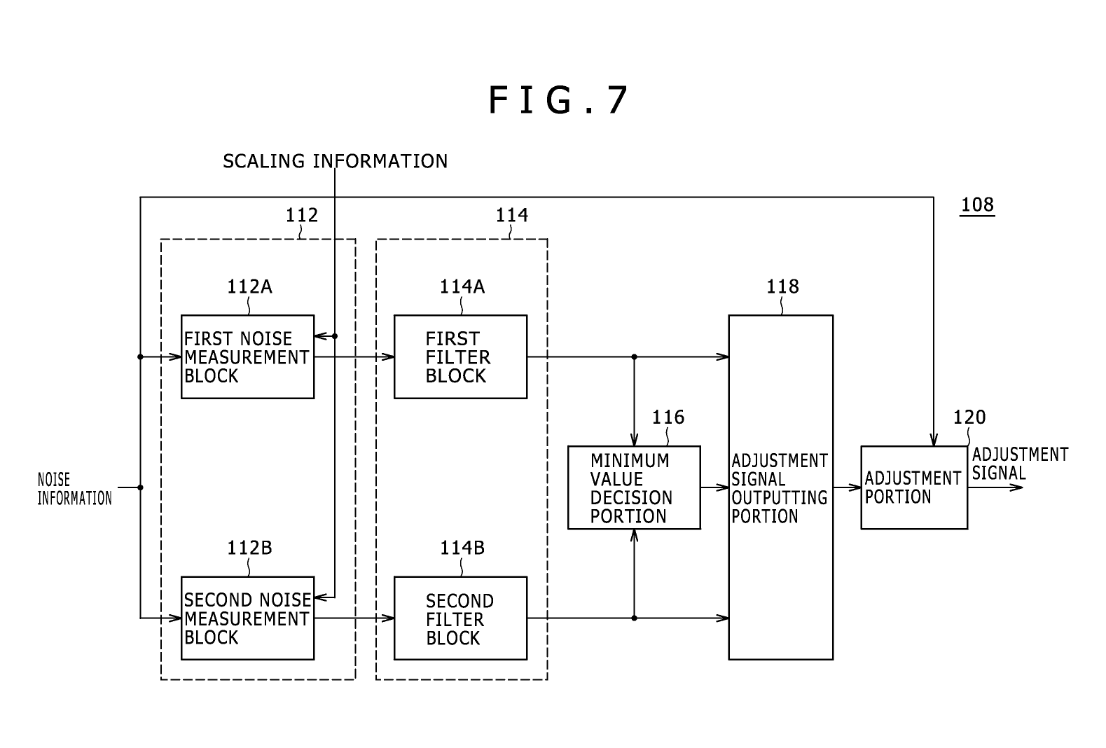

FIG. 7 shows a second configuration example of the adjustment signal production section 108 of the image processing apparatus 100 according to the disclosed technology.

Referring to FIG. 7, the adjustment signal production section 108 according to the second configuration example has a basically similar configuration to that of the adjustment signal production section 108 of the first configuration example described hereinabove with reference to FIG. 5. However, in comparison with the adjustment signal production section 108 according to the first configuration example, the adjustment signal production section 108 according to the second configuration example additionally includes an adjustment portion 120.

The adjustment portion 120 adjusts the degree of correction indicated by the adjustment signal based on information b_str indicative of an intensity of block noise included in the noise information. More particularly, the adjustment portion 120 adjusts the adjustment signal such that, for example, when the value of the information b_str indicative of an intensity of block noise is higher than a predetermined threshold value, the degree of correction is higher. Or, the adjustment portion 120 may adjust the adjustment signal such that, for example, as the value of the information b_str decreases, the degree of correction decreases.

The adjustment signal production section 108 according to the second configuration has a basically similar configuration to that of the adjustment signal production section 108 according to the first configuration example described hereinabove with reference to FIG. 5. Therefore, the adjustment signal production section 108 can produce an adjustment signal based on noise information and scaling information similarly to the adjustment signal production section 108 according to the first configuration example of FIG. 5.

Further, since the adjustment signal production section 108 according to the second configuration example includes the adjustment portion 120, it adjusts the degree of correction indicated by the adjustment signal based on the intensity of block noise detected by the noise detection section 102. Therefore, correction of the image signal on which a result of detection by the noise detection section 102 is reflected can be carried out by the correction section 110 carrying out correction of the image signal based on the adjustment signal outputted from the adjustment signal production section 108 according to the second configuration example.

The image processing apparatus 100 includes the adjustment signal production section 108 having the configuration, for example, shown in FIG. 5 or 7. It is to be noted that the configuration of the adjustment signal production section 108 according to the disclosed technology is not limited to those shown in FIGS. 5 and 7. For example, it is possible for the adjustment signal production section 108 to further adjust the adjustment signal based on a function for evaluating the block distortion intensity for each block boundary and output the adjusted adjustment signal although this is described below as an example of processing by the correction section 110. In the case just described, the image processing apparatus 100 can carry out finer correction.

Referring back to FIG. 1, the configuration example of the image processing apparatus 100 according to the disclosed technology is further described. The correction section 110 corrects a scaling image signal transmitted thereto from the scaling section 106 based on an adjustment signal transmitted thereto from the adjustment signal production section 108. For example, if the adjustment signal transmitted indicates adjustment of the gain of the image signal, then the correction section 110 adjusts the gain of the scaling image signal using a multiplier or the like. On the other hand, if the adjustment signal transmitted indicates a degree of an image process other than adjustment of the gain, then the correction section 110 carries out an image process in response to the level of processing indicated by the adjustment signal, that is, in response to the level regarding the strength of the processing.

The correction section 110 can prevent block noise from being emphasized by correcting the scaling image signal, for example, based on the adjustment signal produced based on noise information and scaling information as described above.

It is to be noted that the processing by the correction section 110 is not limited to that described above. For example, it is possible for the correction section 110 to decide local block noise based on a scaling image signal and adjust the degree of correction indicated by an adjustment signal transmitted thereto in response to a result of the decision. The local block noise may be block noise which is generated, for example, on a block boundary. The correction section 110 corrects the scaling image signal based on the adjusted adjustment signal. In this instance, the image processing apparatus 100 can carry out finer correction.

### Example of the Local Correction Process

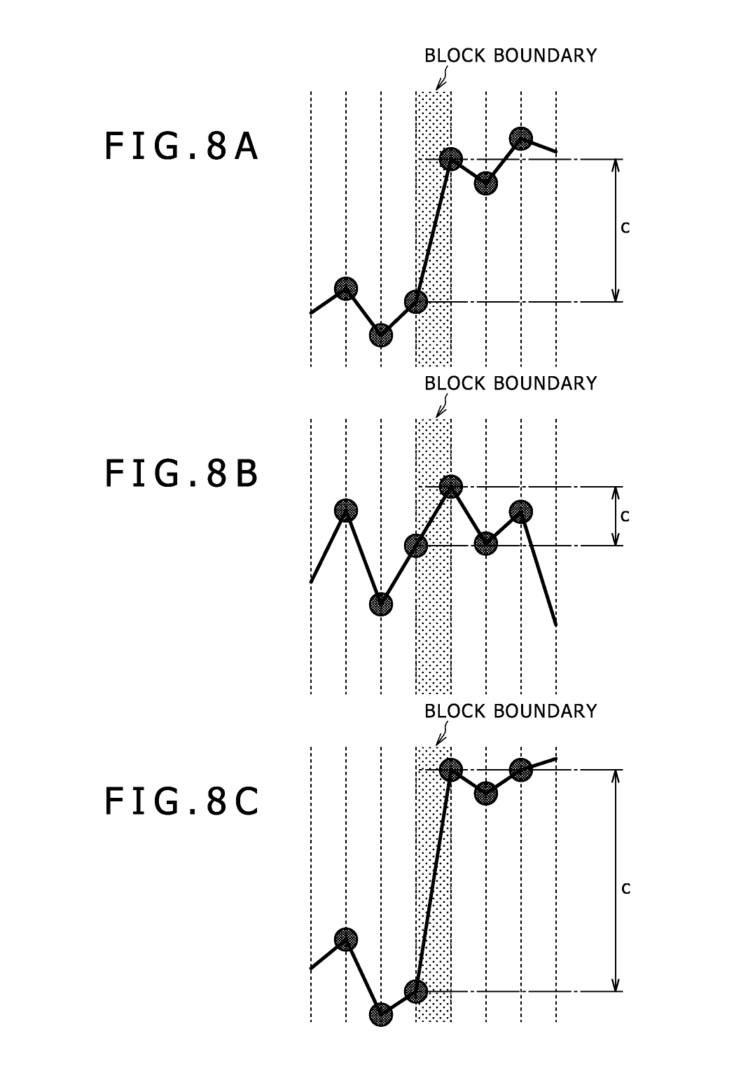

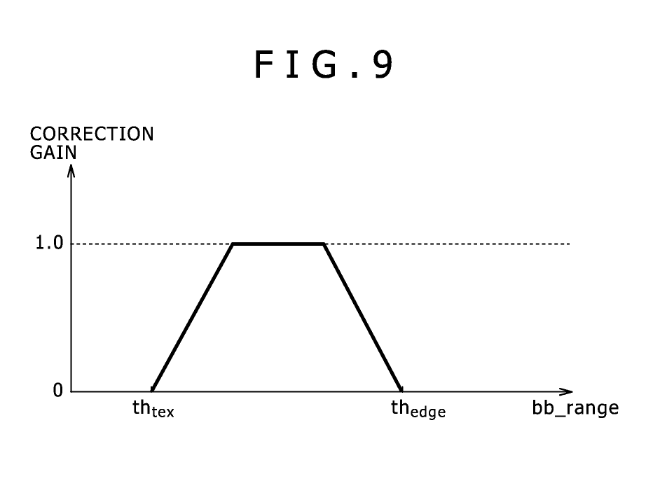

FIGS. 8A to 8C and 9 illustrate an example of a local correction process by the image processing apparatus 100 according to the disclosed technology. More particularly, FIGS. 8A to 8C illustrate an example of a decision method of local block noise, which is generated on a block boundary, by the image processing apparatus 100. Meanwhile, FIG. 9 illustrates an example of adjustment of an adjustment signal in response to a specification result of local block noise by the image processing apparatus 100. In the following, an example of the local correction process by the correction section 110 is described taking a case in which an adjustment signal transmitted from the adjustment signal production section 108 indicates adjustment of the gain of an image signal as an example.

The correction section 110 carries out arithmetic operation of the expression 6 given hereinabove, for example, with regard to a pixel, that is, a noticed pixel x, on a boundary of a scaling image signal. Then, the correction section 110 decides block noise on the block boundary based on a value bb_range, which corresponds to the offset work(x) in the expression 6, representative of a result of the arithmetic operation of the expression 6, a threshold value thₜₑₓ and another threshold value th_{edge} where thₜₑₓ<th_{edge}). The threshold value thₜₑₓ is for the decision of a texture, and, for example, if the value bb_range is equal to or lower than the threshold value thₜₑₓ (or lower than the threshold value thₜₑₓ: this similarly applies also to the description given below), then the correction section 110 determines the difference absolute value c corresponding to the noticed pixel as a texture. Meanwhile, the threshold value th_{edge} is for the decision of an edge, and if the value bb_range is equal to or higher than the threshold value th_{edge} (or higher than the threshold value th_{edge}: this similarly applies also to the description given below), the correction section 110 determines the difference absolute value c corresponding to the noticed pixel as an edge. The threshold value thₜₑₓ for the decision of a texture and the threshold value th_{edge} for the decision of an edge may be, for example, values determined in advance. However, the threshold value thₜₑₓ and the threshold value th_{edge} are not limited to those described above. For example, the threshold value thtₑₓ and the threshold value th_{edge} may be values set by the user.

More particularly, for example, if an offset, that is, the difference absolute value c, on a block boundary is greater than offsets, that is, difference absolute values a, b, d and e, around the block boundary, for example, if thₜₑₓ≦bb_range<th_{edge} as seen in FIG. 8A, then the correction section 110 decides the offset, that is, the difference absolute value c, as block noise. On the other hand, for example, if an offset on a block boundary is not greater than offsets around the block boundary, for example, if bb_range<thₜₑₓ as seen in FIG. 8B, then the correction section 110 decides the offset as a texture but does not decide the offset as block noise. However, for example, if an offset on a block boundary is sufficiently greater than offsets around the block boundary, for example, if th_{edge}<bb_range as seen in FIG. 8C, then the correction section 110 decides the offset as an edge but not as block noise.

Further, the correction section 110 adjusts an adjustment signal corresponding to a block boundary decided as block noise based on a result of the decision described above, for example, in accordance with the value bb_range as seen in FIG. 9. Here, data of a gain curve shown in FIG. 9 are stored, for example, in the storage section or the ROM or the like and are suitably read out by the correction section 110.

The correction section 110 implements the local correction process, for example, by adjusting the degree of correction indicated by the adjustment signal and correcting to the scaling image signal based on the adjusted adjustment signal as described hereinabove. It is to be noted that naturally the local correction process by the image processing apparatus 100 according to the disclosed technology is not limited to that described above.

Further, in the case where the correction section 110 carries out the local correction process, it includes, for example, in addition to the configuration for correction of an image signal such as a multiplier, a processing circuit for exclusive use having an arbitrary configuration for carrying out such a local correction process as described above. However, the configuration of the correction section 110 is not limited to that just described. For example, in the image processing apparatus 100 according to the disclosed technology, the control section may play a role of the correction section 110, and the correction section 110 may be configured from a processing circuit for universal use which can carry out also some other process.

In the case where the image processing apparatus 100 has, for example, the configuration described hereinabove with reference to FIG. 1, it carries out (A) a process of detecting block noise based on an input image signal and outputting noise information, (B) a process of carrying out a scaling process for the input image signal and outputting scaling information, (C) a process of outputting an adjustment signal based on the noise information and the scaling information, and (D) a process of correcting a scaling image signal based on the adjustment signal. Here, by executing the processes (A) to (D) described above, it is implemented to produce the adjustment signal based on the noise information and the scaling information and correct the scaling image signal based on the adjustment signal. In other words, the processes (A) to (D) correspond to the processing of the image processing method according to the disclosed technology described above. Therefore, the image processing apparatus 100 can execute the image processing method according to the embodiment of the disclosed technique described above, for example, by the configuration described hereinabove with reference to FIG. 1.

Accordingly, the image processing apparatus 100 can achieve improvement in picture quality in the case where a scaling process is carried out for an image signal in a compression coded form.

It is to be noted that the configuration of the image processing apparatus 100 according to the disclosed technology is not limited to that described hereinabove with reference to FIG. 1. For example, while FIG. 1 shows the configuration wherein the image processing apparatus 100 includes the noise reduction section 104, the image processing apparatus 100 according to the disclosed technology can have an alternative configuration wherein it does not include the noise reduction section 104. Even with the configuration just described, since the image processing apparatus 100 can correct a scaling image signal based on an adjustment signal produced based on noise information and scaling information, block noise can be prevented from being emphasized. Therefore, since degradation of the picture quality caused by emphasis of block noise which possibly occurs where the technique in the past is used can be prevented, higher picture quality than that achieved where the technique in the past is used can be achieved.

As described above, the image processing apparatus 100 according to the disclosed technology produces an adjustment signal based on noise information indicative of block noise detected based on an input image signal and scaling information indicative of an enlargement ratio or a reduction ratio in a scaling process, and corrects a scaling image signal based on the adjustment signal. Here, even if some other process such as scaling is carried out between a noise detection section for detecting block noise and a correction section for carrying out an image process for enhancement of the picture quality, the image processing apparatus 100 carries out the image process taking an influence of a different process into consideration. Therefore, even if, for example, linear scaling or nonlinear scaling is carried out for the input image signal, the image processing apparatus 100 does not emphasize the block noise by the image process, that is, by the correction process. In other words, the image processing apparatus 100 can implement a more natural image process also for an image which suffers from block noise.

Accordingly, the image processing apparatus 100 can achieve improvement in picture quality in the case where the scaling process is carried out for an image signal in a compression coded form.

Although the disclosed technology is described in detail above taking the image processing apparatus 100 as a preferred embodiment thereof, the embodiment of the technology is not limited to the embodiment described above. The embodiment of the disclosed technology can be applied to various apparatus which can carry out processing of an image signal including computers such as, for example, a PC (Personal Computer) and a PDA (Personal Digital Assistant), display apparatus such as television receivers, portable communication apparatus such as portable telephone sets, image/music reproduction apparatus or image/music recording and reproduction apparatus and game machines.

### 3. Program According to the Embodiment

A program for causing a computer to function as the image processing apparatus according to the disclosed technology, that is, a program for implementing the process according to the image processing method according to the disclosed technique such as a program for implementing the processes (A) to (D) described hereinabove, can achieve improvement in picture quality in the case where a scaling process is carried out for an image signal in a compression coded form.

While a preferred embodiment of the disclosed technology has been described above with reference to the accompanying drawings, naturally the disclosed technology is not limited to the embodiment. It is apparent that a person skilled in the art could have made various alterations or modifications without departing from the spirit and scope of the disclosed technology as defined in claims, and it is understood that also such alterations and modifications naturally fall within the technical scope of the disclosed technology.

For example, while FIG. 1 shows the configuration wherein the image processing apparatus 100 produces an adjustment signal based on noise information and scaling information, the image processing apparatus according to the disclosed technology is not limited to that of the configuration described above. For example, in the case where the image processing apparatus according to the disclosed technology carries out some different process by which the detected position of the block noise varies between the noise detection section and the correction section, the image processing apparatus can have a configuration wherein it produces an adjustment signal using the noise information, scaling information and information obtained by the different process. Also with the configuration just described, since it is possible to prevent block noise from being emphasized by the image process, that is, by the correction process, improvement in picture quality can be anticipated in the case where a scaling process is carried out for an image signal in a compression coded form.

For example, although it is described above that a program, that is, a computer program, for causing a computer to function as an image processing apparatus according to the disclosed technique is provided by the disclosed technology, the disclosed technology can provide also a recording medium on or in which the program is stored.

The configuration just described demonstrates an example of an embodiment of the disclosed technology and is naturally embraced in the technical scope of the disclosed technology.

The present disclosure contains subject matter related to that disclosed in Japanese Priority Patent Application JP 2011-050479 filed in the Japan Patent Office on Mar. 8, 2011, the entire content of which is hereby incorporated by reference.

What is claimed is:

1. An image processing apparatus, comprising:
a noise detection section adapted to detect block noise based on an input image signal in a compression coded form and output noise information indicative of the detected block noise;
a scaling section adapted to carry out a scaling process for carrying out enlargement or reduction of an image indicated by the input image signal for the input image signal and output scaling information indicative of an enlargement ratio or a reduction ratio;
an adjustment signal production section adapted to output an adjustment signal indicative a degree of correction based on the noise information and the scaling information; and
a correction section adapted to correct the image signal for which the scaling process is carried out based on the adjustment signal.

2. The image processing apparatus according to claim 1, wherein said adjustment signal production section includes:
a noise measurement section adapted to specify a distance of block noise in an enlarged or reduced image from a block boundary based on the noise information and the scaling information; and
an adjustment signal output section adapted to output the adjustment signal corresponding to the specified distance from the block boundary.

3. The image processing apparatus according to claim 2, wherein said noise measurement section specifies a distance from the block boundary in a horizontal direction and another distance from a block boundary in a vertical direction.

4. The image processing apparatus according to claim 2, wherein said noise measurement section specifies a distance from the block boundary in a horizontal direction.

5. The image processing apparatus according to claim 2, wherein said noise measurement section specifies a distance distance from a block boundary in a vertical direction.

6. The image processing apparatus according to claim 2, wherein said adjustment signal production section further includes an adjustment section adapted to adjust a degree of correction indicated by the adjustment signal based on information indicative of an intensity of the block noise included in the noise information.

7. The image processing apparatus according to claim 1, wherein said correction section decides local block noise based on the image signal for which the scaling process is carried out and adjusts a degree of correction indicated by the adjustment signal in response to a result of the decision; and
said correction section corrects the image signal for which the scaling process is carried out based on the adjustment signal indicative of the adjusted degree of correction.

8. The image processing apparatus according to claim 1, wherein said adjustment signal production section outputs an adjustment signal for adjusting a gain of an image signal; and
said correction section adjusts a gain of the image signal for which the scaling process is carried out based on the adjustment signal.

9. The image processing apparatus according to claim 1, further comprising:
a noise reduction section adapted to reduce block noise of an input image signal,
wherein said scaling section carries out the scaling process for the input image signal whose block noise is reduced.

10. An image processing method, comprising:
detecting block noise based on an input image signal in a compression coded form and outputting noise information indicative of detected block noise;
carrying out a scaling process for carrying out enlargement or reduction of an image indicated by the input image signal for the input image signal and outputting scaling information indicative of an enlargement ratio or a reduction ratio;
outputting an adjustment signal indicative of a degree of correction based on the noise information and the scaling information; and
correcting the image signal for which the scaling process is carried out based on the adjustment signal.

11. A program for causing a computer to execute:
detecting block noise based on an input image signal in a compression coded form and outputting noise information indicative of detected block noise;
carrying out a scaling process for carrying out enlargement or reduction of an image indicated by the input image signal for the input image signal and outputting scaling information indicative of an enlargement ratio or a reduction ratio;
outputting an adjustment signal indicative of a degree of correction based on the noise information and the scaling information; and
correcting the image signal for which the scaling process is carried out based on the adjustment signal.
